(19) United States
(12) Patent Application Publication
(10) Pub. No.: US 2022/0083980 A1
(43) Pub. Date: Mar. 17, 2022

(54) SYSTEM AND METHOD PROVIDING A REMOTE VIDEO-BASED INTERVIEW

(71) Applicant: Yasaman Almaraz, Marietta, GA (US)

(72) Inventor: Yasaman Almaraz, Marietta, GA (US)

(21) Appl. No.: 17/187,852

(22) Filed: Feb. 28, 2021

Related U.S. Application Data
(60) Provisional application No. 63/078,945, filed on Sep. 16, 2020.

(51) Int. Cl. G06Q 10/10; G06F 16/74; G06F 16/955

(52) U.S. Cl. CPC G06Q 10/1053; G06F 16/9558; G06F 16/748

(57) ABSTRACT

A system and method for providing an online introductory video search and hiring app utilizes a web server. The web server is communicatively interconnected to an applicant computing device and an employer computing device over the Internet. The web server includes a searchable database, a memory having instructions stored thereon, and a processor configured to execute the instructions on the memory causing the web server to perform the method. The method receives applicant profile data from the applicant computing device, receives an introductory video from the applicant computing device, the introductory video promoting themselves as a potential employee, stores the applicant profile data and an introductory video link to the introductory video into a user record within the searchable database, stores the introductory video into a storage location accessible by the introductory video link, receive a search query from the employer computing device, generates search results based upon the search query submission to the searchable database, retrieves the applicant profile data from the searchable database and the introductory video accessed by the introductory video link when the search results contains a match, and transmits the applicant profile data and the introductory video to the employer computing device.

### CROSS-REFERENCE TO RELATED APPLICATION

This application claims priority to U.S. Patent Application No. 63/078,945, titled “1st FIVE,” and filed on Sep. 16, 2020. The entire application is incorporated herein by reference in its entirety.

### TECHNICAL FIELD

This application relates in general to a system and method for providing employee hiring services, and more specifically, to a system and method for providing an online introductory video search and hiring app.

### BACKGROUND

Employers looking to hire applicants can spend a considerable amount of time sorting through resumes and online applications. This pre-screening process can be extensive and exhausting. Phone calls that need to be made to potential hires can cost even more time throughout the hiring process. Employers may waste time on the wrong people for the position.

Therefore, a need exists for a system and method for providing an online introductory video search and hiring app. The present invention attempts to address the limitations and deficiencies of existing solutions according to the principles and example embodiments disclosed herein.

### SUMMARY

In accordance with the present invention, the above and other problems are solved by providing a system and method for providing an online introductory video search and hiring app according to the principles and example embodiments disclosed herein.

In one embodiment, the present invention is a system for providing an online introductory video search and hiring app. The web server is communicatively interconnected to an applicant computing device and an employer computing device over the Internet. The web server includes a searchable database, a memory having instructions stored thereon, and a processor configured to execute the instructions on the memory causing the web server to receive applicant profile data from the applicant computing device, receive an introductory video from the applicant computing device where the introductory video promoting themselves as a potential employee, store the applicant profile data and an introductory video link to the introductory video into a user record within the searchable database, store the introductory video into a storage location accessible by the introductory video link, receive a search query from the employer computing device, generate search results based upon the search query submission to the searchable database, retrieve the applicant profile data from the searchable database and the introductory video accessed by the introductory video link when the search results contains a match, and transmit the applicant profile data and the introductory video to the employer computing device.

In another aspect of the present disclosure, the web server executes addition instructions to transmit the search results to the employer computing device when the search results fails to contain an exact match.

In another aspect of the present disclosure, the introductory video link accesses data storage within the web server.

In another aspect of the present disclosure, the introductory video link accesses data storage within a third-party web server.

In another aspect of the present disclosure, the applicant computing device accesses the web server to submit the applicant profile data and to upload the introductory video using a hyperlink provided by the employer computing device.

In another aspect of the present disclosure, the applicant computing device and the employer computing device access the web server using a web browser.

In another embodiment, the present invention is a method for providing an online introductory video search and hiring app using a web server. The web server is communicatively interconnected to an applicant computing device and an employer computing device over the Internet. The web server includes a searchable database, a memory having instructions stored thereon, and a processor configured to execute the instructions on the memory causing the web server to perform the method. The method receives applicant profile data from the applicant computing device, receives an introductory video from the applicant computing device, the introductory video promoting themselves as a potential employee, stores the applicant profile data and an introductory video link to the introductory video into a user record within the searchable database, stores the introductory video into a storage location accessible by the introductory video link, receives a search query from the employer computing device, generates search results based upon the search query submission to the searchable database, retrieves the applicant profile data from the searchable database and the introductory video accessed by the introductory video link when the search results contains a match, and transmits the applicant profile data and the introductory video to the employer computing device.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for providing an online introductory video search and hiring app according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates an example embodiment of a system for providing an online introductory video search and hiring app according to the present invention.

FIGS. 4a-c illustrate example embodiments of a computing system of software components of a system for providing an online introductory video search and hiring app according to the present invention.

FIG. 5 illustrates a flowchart corresponding to a method performed by software components of a system for providing an online introductory video search and hiring app according to the present invention.

### DETAILED DESCRIPTION

This application relates in general to a system and method for providing employee hiring services, and more specifically, to a system and method for providing an online introductory video search and hiring app according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “individual” and “user” refer to an entity, e.g., a human, using an online introductory video search and hiring app including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s). Some examples are included below in this application.

The term “invention” or “present invention” refers to the invention being applied for via the patent application with the title “1^{st} FIVE Introduction App.” Invention may be used interchangeably with web app.

The terms “communicate” or “communication” refer to any component(s) connecting with any other component(s) in any combination for the purpose of the connected components to communicate and/or transfer data to and from any components and/or control any settings.

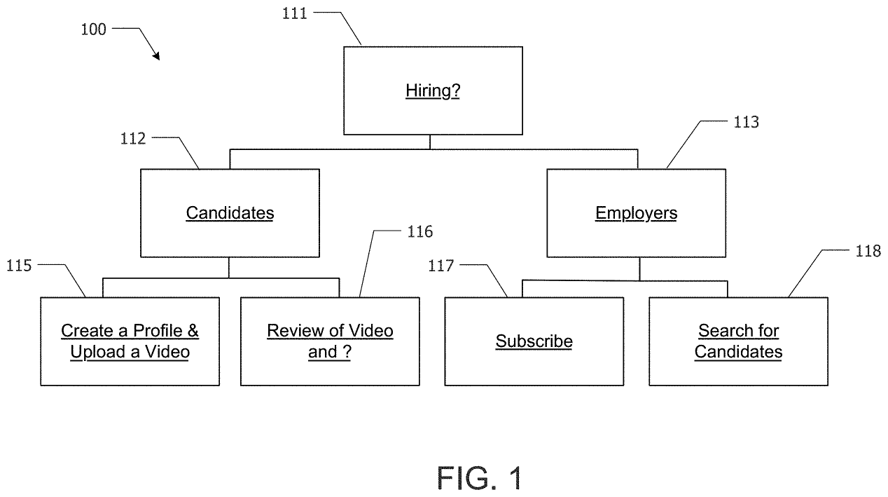

In general, the present disclosure relates to a system and method for providing an online introductory video search and hiring app. To better understand the present invention, FIG. 1 illustrates a system for providing an online introductory video search and hiring app according to the present invention.

Employers begin a hiring process 111 typically by generating a job description that may contain a list of skills and experiences that would provide an employee that best fits the needs of the organization. The candidates 112 need to identify available positions that require their skills and career goals. The employers 113 need to find potential new employees and perform an initial screening to identify the candidate most likely to meet their needs. The 1^{st} FIVE Introduction web app 100 provides users with a mobile applicant introduction platform capable of allowing candidates to create a profile and upload a five-minute video of themselves to prospective employers. The app allows the video 115 to be sent to the employers and other subscription services that can be used to view the video. The video eliminates the need for a first round of scheduled interviews, saving time for both applicant and employer. The app eliminates the need to spend hours and days screening individuals via phone calls and sorting through hundreds of potential resumes.

The 1st FIVE Introduction Web App is an improved online or mobile applicant introduction platform. The platform allows a user to create a profile and upload a video about themselves of less than five minutes. The uploaded video can then be sent to prospective employers and other subscription-based services 117 that may be engaged by prospective employers. This web app eliminates the first round of scheduled interviews that typically are the most time consuming to schedule and conduct while providing the least productive use of everyone's time. The video can be uploaded from a camera or smartphone to the website or application. The video can be shared across multiple platforms and accessed with ease. Employers can search for candidates 118 and then watch the video as the initial screening process and decide to potentially further the hiring process. Once a number of potential candidates are identified, the employer may focus upon and schedule interviews with a smaller number of individuals.

The candidates are responsible to create the above video providing an introduction as this presentation is intended to provide an introduction of the candidate and his or her skills, experiences, and interest in a particular position. The candidate may create a video introduction that is uniquely tailored to a specific employer or may provide a more generalized introduction that may be provided to any number of selected employers. The candidate needs to create and upload the appropriate video and provide access to it to the employer as disclosed herein. Additionally, the uploaded videos may only be viewed from the 1st FIVE Introduction Web App storage online and are not intended to be downloaded or shared with other individuals both for employment purposes and for unauthorized uses. The 1st FIVE Introduction Web App and its web server provides access controls to protect the videos from downloading and misuse.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 101a, laptop computers 101d, desktop computers 101c, 102 tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

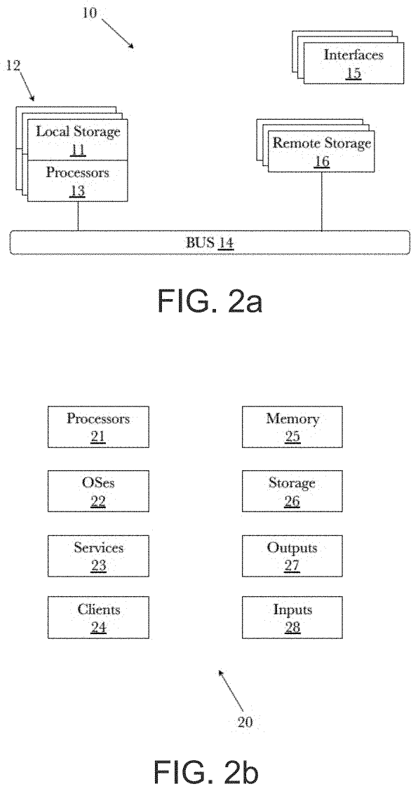

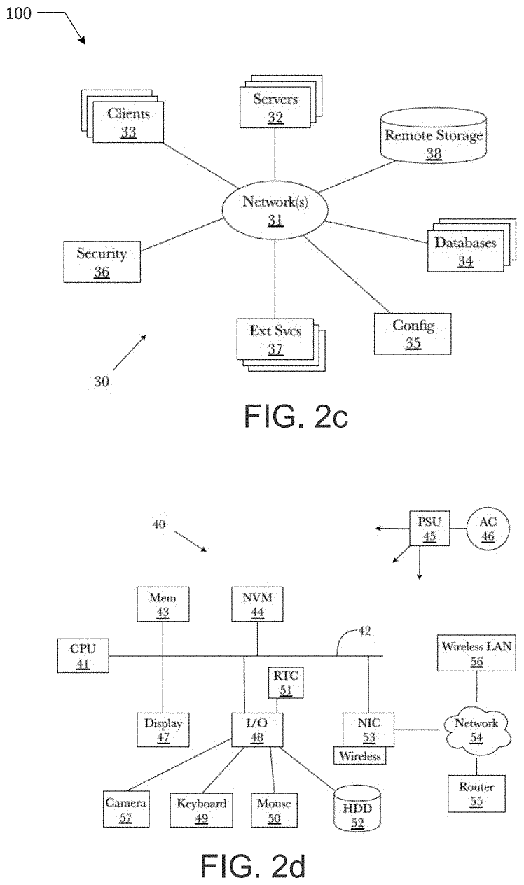

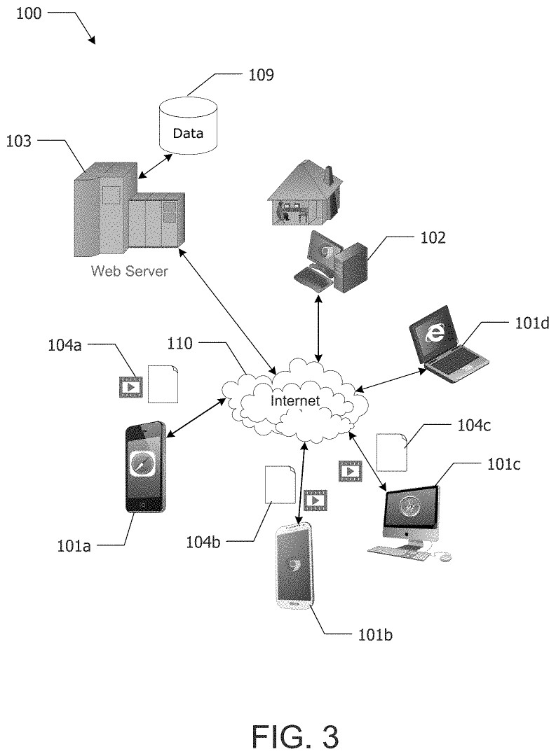

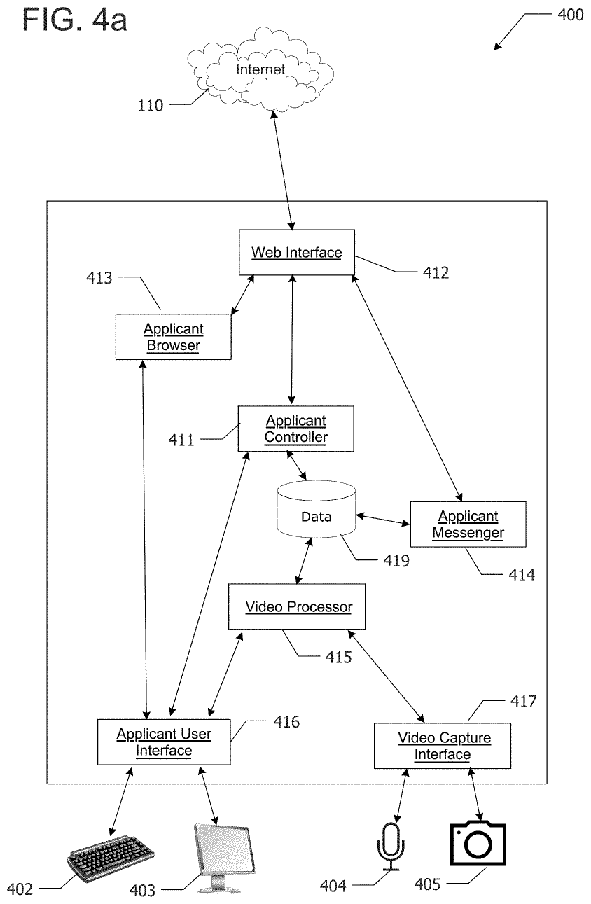

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, a computing device 10 includes one or more central processing units (CPUs) 12, one or more interfaces 15, and one or more buses 14 (such as a peripheral component interconnect (PCI) bus). When acting under the control of appropriate software or firmware, a CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

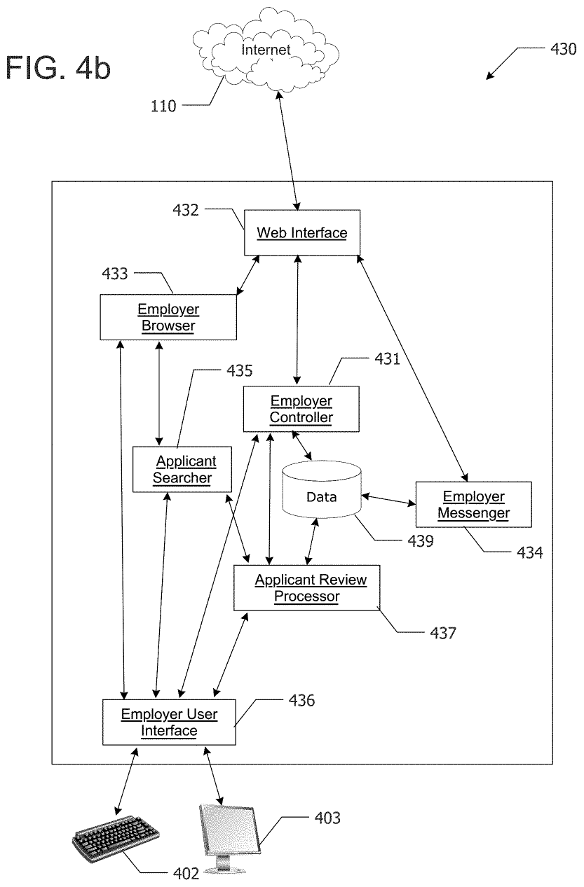

FIG. 3 illustrates an example embodiment of a system for providing an online introductory video search and hiring app according to the present invention. The web-based system 100 comprises a web server 103 communicatively connected to the Internet 110 that may be accessed by an employer computing system 102 and a plurality of applicant computing devices 101a-d. In one possible embodiment, the applicants and employers access the web server 103 using web browsers such as Safari™, Chrome™, Firefox™, and Internet Explorer™, among others. The applicants generate a short 5-minute video and supporting documentation 104a-c that are uploaded to the web server 103 for storage within a searchable database 109. The employers may search the database for candidates, review their videos and related information, and make a decision regarding which of the candidates to contact for an interview.

All of these actions may be performed using a web browser and a server-side web application. In an alternate embodiment, the applicants may interact with a downloaded app that runs on their computing devices to capture and edit a video, to provide additional biographic and background information, and to upload their data to the web server. Similarly, the employer may also use a downloaded app to search for applicants and to watch the uploaded videos to identify potential candidates. All of these downloadable apps may execute on computing devices from personal computers and laptops as well as mobile devices such as tablets and smartphones. The web server 103 may also support both a web browser-based interface as well as a mobile app to permit users to interact with the system 100 either way from variety of devices.

The applicants may provide additional information in a user profile along with an uploaded video to provide contact information, educational and working experiences and accomplishments, and possibly sample work product when appropriate. This additional information may be submitted as a text document such as a resume; however, the video is intended to provide the applicant's background and possible value as an employee. As such, the information may correspond to a set of data fields that are entered into the web browser or application that are then submitted to the web server 103 for inclusion within an applicant's profile. In an alternate embodiment, the web server 103 may provide a database and employer search options for identify potential candidates with the videos uploaded by the applicants being uploaded and stored onto a third-party platform such as Vimeo™ and YouTube™. The web server 103 may interact with the applicants and store the videos onto these third-party platforms to obtain and manage links to the videos as well as utilize the access controls of these third-party platforms to keep the videos inaccessible to the public at large.

The web-based system 100 also may be integrated into an existing employer's recruiting web platform such that an applicant may search the career sites of employers to identify available opportunities and submit an application for a particular opening using the present invention. In an alternate embodiment, the web-based system 100 is a stand-alone platform that employers may access via a web browser. The employer will receive an application from a prospective employee and an indication that a video may be obtained from the web server 103. The employer's HR web site (not shown) may provide an indication and a link to the web-based system 100 suggesting that the applicants create and upload one. The employer may also search the database 459 using name, location, email addresses, and other user identifiable information to locate a video uploaded by the applicant.

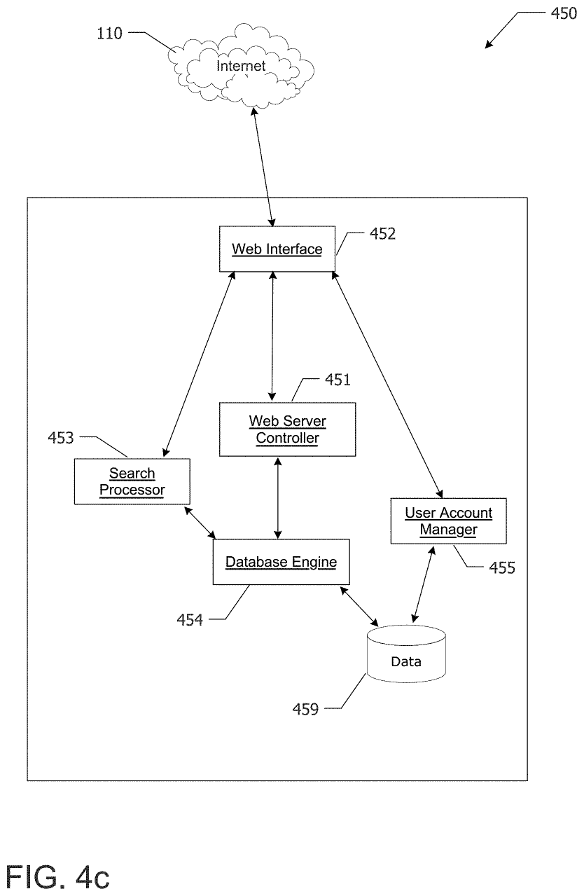

FIGS. 4a-c illustrate example embodiments of a computing system of software components of a system for providing an online introductory video search and hiring app according to the present invention. Each of the three computing devices 101-103 within the web-based system 100 includes a set of software computing components that provide the functionality required to provide the needs of the three different computing platforms. FIGS. 4a-c show the set of software computing components for the applicant app 101, the employer app 102, and the web server 103.

As noted above, the set of software components for each of the three apps may be web server-based components as well as downloaded apps. In an embodiment that uses web server-based components, the set of computing components made available to a user of the web server 103 is based upon a role associated with the user. When a user first starts to use the web-based app system 100, the user registers with the web server 103. A user account is created that is unique for that particular user. A unique user ID and password are created that may be used to authenticate the user when he/she returns at a later date. Each user account includes a user role including applicant and employer that may be used to identity the set of software components that are to be used when a particular user logs into the web server 103.

The web server 103 also may use additional factors to authenticate a user to ensure that the user corresponds to the individual accessing the web server 103 at any point in time. These additional factors may include biometric factors such as fingerprints, facial recognition, voice identification, and similar unique biometric characteristics associated with a user. A two-factor authentication process sends a one-time code having a short valid time period for use to a previously stored email address or mobile number that must be entered by the user to complete the authentication process.

FIG. 4a shows the set of software computing components that perform the functions of the applicant app 400. The set of software computing components 400 used by an applicant app include an applicant controller 411, a web interface 412, an applicant browser 413, an applicant messenger 414, a video processor 415, an applicant user interface 416, a video capture interface 417, and local data storage 419. The set of software computing components that perform the functions of the applicant app 400 utilize a display device 403 and input device 402 , such as a keyboard or touch screen, as well as a camera 405 and microphone 404, that are typically part of a user's computing device.

The applicant controller 411 acts as a central overall controller for the set of software components 412-417. User commands from the applicant user interface 416 are received and processed to determine actions to be taken, and then mobile app commands are passed to the other software components 412-417, as needed, to implement the actions to be taken. The applicant controller 411 also works with the user account manager 455 on the web server 103 to determine whether or not a particular user of the applicant app 400 at any particular point in time is authorized to access particular data entries within the database 459 and to take particular actions that may be requested. As such, different user accounts may be authorized to perform an individual user set of tasks associated with each user and to access a particular subset of data. The applicant controller 411 is responsible for enforcing these security privileges.

The web interface 412 permits the applicant app 400 to communicate with remote employer computing devices 102 and the web server 103. The web interface 412 performs all of the data formatting, computer-to-computer communications, encryption processing, and all similar operations needed by the computing device to communicate with other devices.

The applicant browser 413 provides a data connection to the web server 103 to communicate user profile and video data for uploading, to create a user account on the web server 103, and to perform any searching for available positions that may be stored on the web server 103 to request creation and submission of profile and video data for consideration for a position. The applicant browser 413 performs all data communications, data formatting, and user authentication with the web server 103 as needed.

The applicant messenger 414 provides applicants to exchange messages with employers to discuss consideration of an available position. The applicant messenger 414 may send and receive messages such as email, SMS messages, and live chat messaging with employers listing positions on the web server 103. The applicant messenger 414 also may contain an audio and video-based chat function to permit applicants and employers to speak with each other from within the application 100. The applicant messenger 414 also may provide additional contact information such as email address, telephone numbers, Skype IDs, mailing addresses, and any other means for communication outside of the application 100.

The video processor 415 receives captured video and audio data from the video capture interface 417 to create, edit, store, and upload the video to the web server 103 for inclusion within the applicant's profile. The video processor 415 receives user commands from the applicant user interface 416 to send instructions to the video capture interface 417 to activate and deactivate the microphone 404 and camera 405 that are part of the applicant computing devices. The video processor 415 also stores the applicant completed video onto local storage 419 and sends the applicant completed video to the applicant browser 413 for uploading to the web browser 103.

The applicant user interface 416 provides input and output processing to provide a driver with messages and data needed to perform the applicant profile and video creation and uploading functions. This interface module 416 also accepts commands from the driver to instruct the application to perform these tasks.

The video capture interface 417 provides input and output data connection between the video processor 415 and the camera 405 and microphone 404 of the applicant computing device. The video capture interface 417 sends commands to the camera 405 and the microphone 404 to activate and deactivate the generation of the video and audio data to be captured by the video processor 415. The video capture interface 417 also receives and formats the incoming data streams into a data format used by the video processor depending upon the particular devices that are part of the applicant computing device.

The local data storage 419 is permanent data storage available on the applicant computing device to retain data used by the set of software computing components that perform the functions of the applicant app 400. This data may include user profile data, user login data associated with the web server 103, biometric data, among others. The local data storage 419 may be part of a hard drive, a solid-state storage device (SSD), or removable storage devices attached to the applicant computing device.

FIG. 4b shows the set of software computing components that perform the functions of the employer app 430. The set of software computing components 400 used by an employer app include an employer controller 431, a web interface 432, an employer browser 433, an employer messenger 434, an applicant searcher 435, an employer user interface 436, an applicant review processor 437, and local data storage 439. The set of software computing components that performs the functions of the employer app 430 utilizes a display device 403 and input device 402 , such as a keyboard or touch screen that are typically part of a user's computing device.

The employer controller 431 acts as a central overall controller for the set of software components 432-437. User commands from the employer user interface 436 are received and processed to determine actions to be taken, and then mobile app commands are passed to the other software components 432-437, as needed, to implement the actions to be taken. The employer controller 431 also works with the user account manager 455 on the web server 103 to determine whether or not a particular user of the employer app 430 at any particular point in time is authorized to access particular data entries within the database 459 and to take particular actions that may be requested. As such, different user accounts may be authorized to perform an individual user set of tasks associated with each user and to access a particular subset of data. The employer controller 431 is responsible for enforcing these security privileges.

The web interface 432 permits the employer app 430 to communicate with remote applicant computing devices 101a-d and the web server 103. The web interface 432 performs all of the data formatting, computer-to-computer communications, encryption processing, and all similar operations needed by the computing device to communicate with other devices

The employer browser 433 provides a data connection to the web server 103 to retrieve user profile and video data for review, to create a user account on the web server 103, and to perform any searching for available applicants that may be stored on the web server 103 to request creation and submission of profile and video data for consideration for a position. The applicant browser 433 performs all data communications, data formatting, and user authentication with the web server 103 as needed.

The employer messenger 434 provides applicants to exchange messages with employers to discuss consideration of an available position. The employer messenger 434 may send and receive messages such as email, SMS messages, and live chat messaging with applicants responding to listed positions on the web server 103. The employer messenger 434 also may contain an audio- and video-based chat function to permit applicants and employers to speak with each other from within the application 100. The employer messenger 434 may also provide additional contact information such as email address, telephone numbers, Skype IDs, mailing addresses, and any other means for communication outside of the application 100

The applicant searcher 435 communicates with the web server 103 via the employer browser 433 to perform searches for applicants stored within the database 459 on the web server 103. The applicant searcher 435 creates search queries based upon user input from the employer user interface 436, submits the search queries in an appropriate format used by the web server 103, and receives search results from the web server 103 for presentation to the employer via the applicant review processor 437. The applicant searcher 435 also may maintain search queries, search results, and related data onto the local data storage 439 for later retrieval and use.

The employer user interface 436 provides input and output processing to provide a driver with messages and data needed to perform the employer search and review of applicant profiles and videos. This interface module 436 also accepts commands from the driver to instruct the application to perform these tasks,

The applicant review processor 437 retrieves applicant profile data and videos from the database 459 on the web server 103 and presents them to the employer for review via the employer user interface 436. The applicant review processor 437 may permit the employer to send messages to applicants using the employer messenger 433 as well as set up live chat sessions with applicants when possible. The applicant review processor 437 permits the employer to add notes and comments to the reviewed profile that may be retained within local data storage 439 for use throughout the hiring process. The applicant review processor 437 may also use the employer messenger 433 to send the applicant profile and video to other hiring managers and decision makers for comment and review.

The local data storage 439 is permanent data storage available on the employer computing device to retain data used by the set of software computing components that perform the functions of the employer app 430. This data may include user profile data, user login data associated with the web server 103, biometric data among others. The local data storage 439 may be part of a hard drive, a solid-state storage device (SSD), or removable storage devices attached to the employer computing device.

FIG. 4c shows the set of software computing components that perform the functions of the web server app 450. The set of software computing components 400 used by an applicant app include a web server controller 451, a web interface 452, a search processor 453, a database engine 454, a user account manager 455, and web-based data storage 459.

The web server controller 451 acts as a central overall controller for the set of software components 453-455. User communication from the employer app 430 and applicant app 400 are received and processed to determine actions to be taken, and then web server app commands are passed to the other software components 452-455, as needed, to implement the actions to be taken. The web server controller 451 also works with the user account manager 455 to determine whether or not a particular user at any particular point in time is authorized to access particular data entries within the database 459 and to take particular actions that may be requested. As such, different user accounts may be authorized to perform an individual user set of tasks associated with each user and to access a particular subset of data. The web server controller 451 is responsible for enforcing these security privileges.

The web interface 452 permits the web server app 450 to communicate with remote employer computing devices 102 and remote applicant computing devices 101a-d. The web interface 452 performs all of the data formatting, computer-to-computer communications, encryption processing, and all similar operations needed by the computing device to communicate with other devices

The search processor 453 communicates with the applicant app 400 and the employer app 430 to perform searches for applicants stored within the database 459. The search processor 453 receives search queries based upon user input from a user, processes the search queries, generates search results, and sends search results to requesting users. The search processor 453 also may maintain search queries, search results, and related data onto the local data storage 459 for later retrieval and use.

The database engine 454 processes all database operations for the applicant video and data database 459. These operations include insertion of applicant video and data profiles into the database 459, deletion of applicant video and data profiles from the database 459, searching and retrieving applicant video and data profiles from the database 459, and indexing the database 459 to maintain efficient searching when needed.

The user account manager 455 permits users to connect to and access the web server 103. The user account manager 455 is responsible for creating and managing user accounts for the applicant users 101 and the employer users 102. The user account manager 455 also is used in authenticating a user based upon user input. Typically, the user input uses a username and password. Multi-factor authentication, use of one-time passwords, and similar secure authentication mechanisms may be included in the user profile. For every sign in the system will recognize the user type, i.e., applicants 101 and employers 102, along with all past activities from account details in the database 459. Based on user role, the web server 103 behavior will change.

The web-based data storage and the applicant video and data database 459 are stored on storage devices that are attached to the web server 103. The database data as well as other data used by the set of software components 450 of the web server 103 are maintained on these storage devices to permit the web server 103 and its corresponding set of software components 450 to function properly.

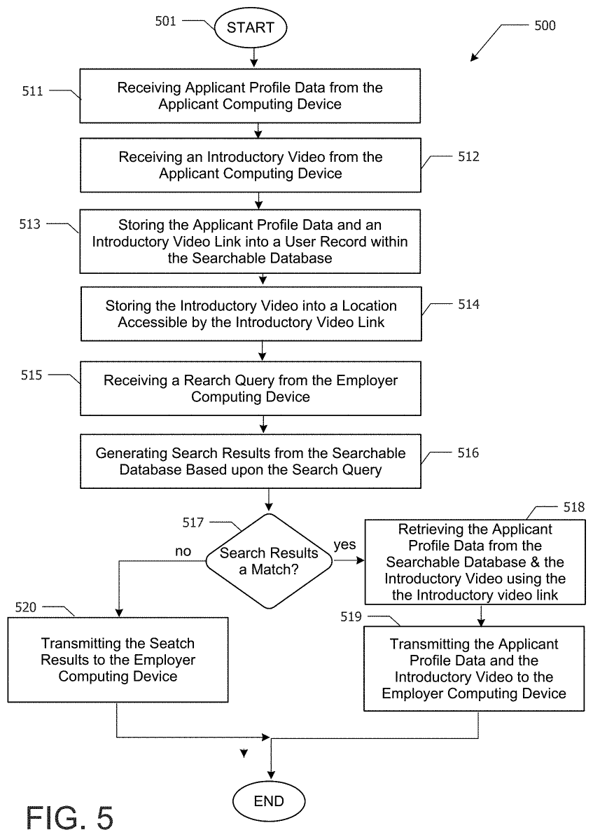

FIG. 5 illustrates a flowchart corresponding to a method performed by software components of a system for providing an online introductory video search and hiring app according to the present invention. The process 500 begins 501 and in step 511, the web server 103 receives applicant profile data from the applicant computing device and receives an introductory video from the applicant computing device in step 512. The introductory video promoting themselves as a potential employee. The web server 103, in step 513, stores the applicant profile data and an introductory video link to the introductory video into a user record within the searchable database, and in step 514, stores the introductory video into a storage location accessible by the introductory video link.

The web server 103 receiving a search query from the employer computing device in step 515. In step 516, the web server 103 generates search results based upon the search query submission to the searchable database. Test step 517 determines whether the search results contains a match, and if so, retrieves, in step 518, the applicant profile data from the searchable database and the introductory video accessed by the introductory video link when the search results contains a match and transmits the applicant profile data and the introductory video to the employer computing device in step 519 before ending 502; otherwise the web server 103 transmits the search results to the employer computing device in step 519 before ending 502.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control, and transfer of content(s) or data between any combination of the components.

What is claimed is:

1. A method for providing an online introductory video search and hiring app using a web server, the web server configured to communicatively interconnect to an applicant computing device, and an employer computing device over the Internet, the web server comprises, a searchable database, a memory having instructions stored thereon, and a processor configured to execute the instructions on the memory causing the web server to perform the method, the method comprising:
receiving applicant profile data from the applicant computing device;
receiving an introductory video from the applicant computing device, the introductory video promoting themselves as a potential employee;
storing the applicant profile data and an introductory video link to the introductory video into a user record within the searchable database;
storing the introductory video into a storage location accessible by the introductory video link;
receiving a search query from the employer computing device;
generating search results based upon the search query submission to the searchable database;
retrieving the applicant profile data from the searchable database and the introductory video accessed by the introductory video link when the search results contains a match; and
transmitting the applicant profile data and the introductory video to the employer computing device.

2. The method according to claim 1, wherein the method further comprises transmitting the search results to the employer computing device when the search results fails to contain an exact match.

3. The method according to claim 2, wherein the introductory video link accesses data storage within the web server.

4. The method according to claim 2, wherein the introductory video link accesses data storage within a third-party web server.

5. The method according to claim 1, wherein the applicant computing device accesses the web server to submit the applicant profile data and to upload the introductory video using a hyperlink provided by the employer computing device.

6. The method according to claim 1, where the applicant computing device and the employer computing device access the web server using a web browser.

7. A system for providing an online introductory video search and hiring app, the system comprises a web server, one or more employer computing devices, and an applicant computing device, the web server configured to communicatively interconnect to the applicant computing device, and the one or more employer computing device over the Internet, the web server comprises:
a searchable database;
a memory having instructions stored thereon; and
a processor configured to execute the instructions on the memory to cause the web server to:
receive applicant profile data from the applicant computing device;
receive an introductory video from the applicant computing device, the introductory video promoting themselves as a potential employee;
store the applicant profile data and an introductory video link to the introductory video into a user record within the searchable database;
store the introductory video into a storage location accessible by the introductory video link;
receive a search query from the employer computing device;
generate search results based upon the search query submission to the searchable database;
retrieve the applicant profile data from the searchable database and the introductory video accessed by the introductory video link when the search results contains a match; and
transmit the applicant profile data and the introductory video to the employer computing device.

8. The system according to claim 7, wherein the processor is further to cause the web server to transmit the search results to the employer computing device when the search results fails to contain an exact match.

9. The system according to claim 8, wherein the introductory video link accesses data storage within the web server.

10. The system according to claim 8, wherein the introductory video link accesses data storage within a third-party web server.

11. The system according to claim 7, wherein the applicant computing device accesses the web server to submit the applicant profile data and to upload the introductory video using a hyperlink provided by the employer computing device.

12. The system according to claim 7, where the applicant computing device and the employer computing device access the web server using a web browser.
